(19) United States
(12) Patent Application Publication
(10) Pub. No.: US 2014/0004610 A1
(43) Pub. Date: Jan. 2, 2014

(54) PROCESSES AND APPARATUSES FOR CONVERTING A FEEDSTOCK

(71) Applicant: Lance Awender Baird, Prospect Heights, IL (US)

(72) Inventor: Lance Awender Baird, Prospect Heights, IL (US)

(73) Assignee: UOP LLC, Des Plaines, IL (US)

(21) Appl. No.: 13/536,472

(22) Filed: Jun. 28, 2012

(51) Int. Cl. G01N 31/00

(52) U.S. Cl. 436/55; 422/62

(57) ABSTRACT

Processes and apparatuses for converting a feedstock are provided. In one embodiment, a process of converting biomass includes flowing the biomass and a gas through a process unit. A default value is provided for a frequency of measuring a process condition in the process unit. The process condition is measured according to the frequency to obtain process condition measurements. The process condition measurements are evaluated to assess the stability of the process condition. Then, it is determined whether to change the default value depending on the stability of the process condition.

### TECHNICAL FIELD

The present invention generally relates to processes and apparatuses for converting a feedstock, and more particularly relates to processes and apparatuses that intermittently measure process conditions through instrument taps and purge the instrument taps.

### BACKGROUND

The conversion of biomass feedstock into bio-oil, i.e., a renewable liquid fuel derived from biological sources, has become a valuable process for producing an alternative fuel source. Biomass feedstock includes, but is not limited to, lignin, plant parts, fruits, vegetables, plant processing waste, wood chips, chaff, grains, grasses, corn and corn husks, weeds, aquatic plants, hay, recycled and non-recycled paper and paper products, and any cellulose-containing biological material or material of biological origin. Typically, the biomass feedstock is ground into particles and delivered to a conversion reactor. In the conversion reactor, the biomass feedstock can be converted to bio-oil through catalytic or thermal processes. For both catalytic and thermal conversion processes, the biomass particles may be transported through the conversion reactor by a carrier gas. Further, the biomass particles may be contacted with solid catalyst particles or with solid heat transfer medium particles. The carrier gas, biomass particles, solid catalyst particles and/or solid heat transfer medium particles form a fluidized solid stream.

As the biomass is converted during the catalytic or thermal process, process conditions may vary and are typically monitored. In fact, process conditions in a conversion reactor are generally monitored continuously. Specifically, instrument taps in the reactor are opened and are in fluid communication with measuring instruments. The measuring instruments may include pressure, differential pressure, temperature, level measurement instruments, and the like. During processing, the solid catalyst particles, the solid heat transfer medium particles, or the biomass itself can enter into the instrument taps and become lodged in or otherwise obstruct the measuring instruments. Therefore, it is desirable to reduce or prevent lodging of particles in or obstruction of the measuring instruments or taps.

Generally, a purge gas is used to reduce or prevent lodging of particles in or obstruction of the measuring instrument. It is typical that the purge gas be continuously flowed to the instrument tap. However, the purge gas is commonly air, and the introduction of additional oxygen through instrument taps reduces the yield of bio-oil from the biomass feedstock proportionally to the amount of oxygen added. Therefore, a reduction of the amount of oxygen delivered to the conversion reactor through instrument tap purges would improve the conversion process yield.

Accordingly, it is desirable to provide processes and apparatuses for converting a feedstock with improved yield. Further, it is desirable to provide processes and apparatuses for converting a feedstock which reduces ingress of oxygen. Furthermore, other desirable features and characteristics will become apparent from the subsequent detailed description and the appended claims, taken in conjunction with the accompanying drawings and the foregoing technical field and background.

### BRIEF SUMMARY

Processes and apparatuses for converting a feedstock are provided. In accordance with an exemplary embodiment, a process of converting biomass includes flowing the biomass and a gas through a process unit. A default value is provided for a frequency of measuring a process condition in the process unit. The process condition is measured according to the frequency to obtain process condition measurements. The process condition measurements are evaluated to assess the stability of the process condition. Then, it is determined whether to change the default value depending on the stability of the process condition.

In accordance with another exemplary embodiment, a process for monitoring a fluidized solid stream includes contacting a gas with solids to form the fluidized solid stream. The process intermittently opens fluid communication with the stream through a tap at a first frequency. Further, the method includes measuring a process condition at the tap to obtain measured process conditions and simultaneously purging solids from the tap while fluid communication with the fluidized solid stream is open.

In accordance with another exemplary embodiment, an apparatus for converting a feedstock to bio-oil includes a conversion reactor for receiving the feedstock. The conversion reactor includes a reaction zone adapted to convert the feedstock to bio-oil. A tap is connected to the reaction zone and a monitoring instrument configured for measuring a condition in the reaction zone is fluidly connected to the tap by a conduit. The apparatus includes a valve connected to the conduit between the measuring instrument and the tap for selectively opening and closing fluid communication therebetween. Further, a gas source is connected to the conduit between the valve and the measuring instrument for purging the tap of solids. The apparatus further includes a controller electronically connected to the measuring instrument and the valve. The controller is configured to intermittently open the valve to obtain a condition measurement and to simultaneously purge the tap of solids.

### BRIEF DESCRIPTION OF THE DRAWINGS

Embodiments of processes and apparatuses for converting a feedstock will hereinafter be described in conjunction with the following drawing figures, wherein like numerals denote like elements, and wherein:

FIG. 1 is a schematic illustrating an apparatus for converting a feedstock including a process unit adapted for selective measurement and purging in accordance with various embodiments herein;

FIG. 2 is a schematic illustrating an alternate apparatus for converting a feedstock in accordance with various embodiments herein;

FIG. 3 is a schematic illustrating an apparatus with a plurality of measurement/purge units for converting a feedstock in accordance with various embodiments herein; and

FIG. 4 is a flow chart illustrating steps for setting and modifying a process condition measurement frequency in accordance with various embodiments herein.

### DETAILED DESCRIPTION

The following detailed description is merely exemplary in nature and is not intended to limit the processes and apparatuses for converting a feedstock. Furthermore, there is no intention to be bound by any expressed or implied theory presented in the preceding technical field, background or brief summary, or in the following detailed description.

It is contemplated herein that the conversion of a feedstock can be improved under conditions in which oxygen levels are controlled. Specifically, the processes and apparatuses for converting feedstocks described herein can be used to limit the volume of oxygen introduced to a process unit, such as a conversion reactor or any chamber or conduit through which a fluidized solid stream flows. In many conventional processes, oxygen continuously enters process units through instrument taps purged with air. The processes and apparatuses for converting feedstocks described herein reduce the introduction of oxygen through the instrument taps by only intermittently taking measurements through, and simultaneously purging, the instrument taps. Further, the processes and apparatuses for converting feedstocks described herein monitor the measurements taken and, based on the monitored measurements, determine a frequency for future measurements and purges.

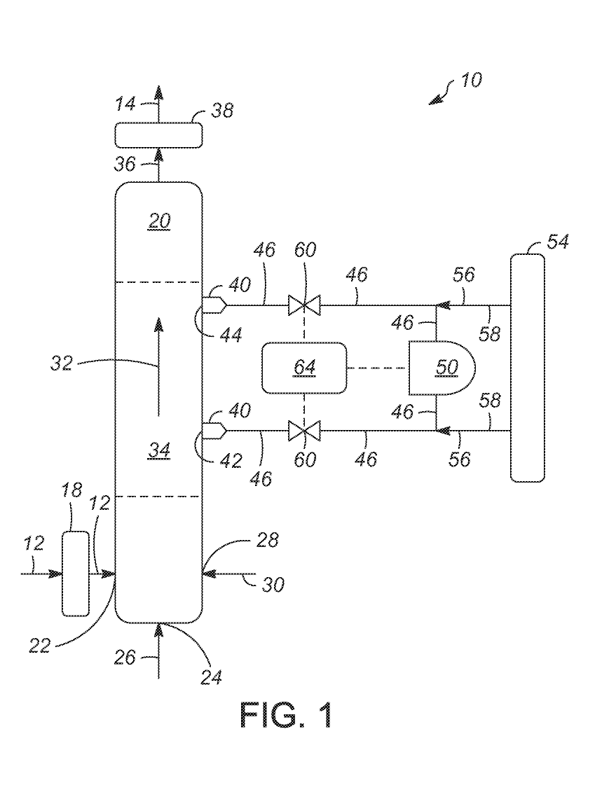

In accordance with the various embodiments herein, FIG. 1 illustrates an apparatus 10 for converting a feedstock 12, such as biomass including, without limitation, lignin, plant parts, fruits, vegetables, plant processing waste, wood chips, chaff, grains, grasses, corn and corn husks, weeds, aquatic plants, hay, recycled and non-recycled paper and paper products, and any cellulose-containing biological material or material of biological origin, to produce a product 14, such as bio-oil or pyrolysis oil. As in a conventional conversion system, the apparatus 10 includes a feed chamber 18 formed by, for example, an auger, a screw feed device, a conveyor, or other batch feed device. The reactor feed chamber 18 is further selectively connected to a process unit 20, such as a catalytic conversion or thermal conversion reactor, configured to convert the feedstock 12 to a product oil. The process unit 20 includes a feedstock inlet 22 for receiving the feedstock 12 from the feed chamber 18. Further, the process unit 20 includes a carrier gas inlet 24 for receiving a carrier gas 26. The process unit 20 may also include a solid heat transfer medium inlet 28 to receive hot heat transfer medium 30, such as sand, catalyst, or other inert particulate. Alternatively, the heat transfer medium 30 may be mixed with and carried by the carrier gas 26 through the carrier gas inlet 24. When combined, the carrier gas, solid feedstock particles, and solid particles of catalyst or heat transfer medium, form a fluidized solid stream 32 that enters and passes through a process or reaction zone 34 within the process unit 20 where the feedstock is catalytically or thermally converted to an oil. After conversion, the resulting effluent 36, comprising vaporized oil, carbon oxides, nitrogen, water vapor, char, and heat transfer medium or catalyst, exits the process unit 20 and is fed to another process unit 38, such as a condenser, which separates the product 14 from the effluent 36.

Exemplary process unit 20 is outfitted with an instrument tap 40 at location 42 and an instrument tap 40 at location 44. While two instrument taps 40 are shown in the exemplary process unit 20, more (or fewer) instrument taps 40 may be provided in other locations as desired. Typically, each instrument tap 40 defines an inner channel having a one-inch (2.54 cm) or two-inch (5.08 cm) diameter in fluid communication with the process unit 20. Further, the inner channel of each instrument tap 40 is in fluid communication with a conduit 46 that is connected to a measuring instrument 50. As a result, the measuring instrument 50 is in fluid communication with the process unit 20 at location 42 and location 44 through the conduits 46 and taps 40.

An exemplary conduit 46 has a ¾-inch (1.905 cm) diameter and includes a reducing flange (not shown) connecting the conduit 46 to the respective tap 40. Further, connection between the conduit 46 and the measuring instrument 50 is, for example, performed with a two-inch (5.08 cm) diameter opening, and the conduit 46 may include a reducer (not shown) to accommodate the diameter change. Depending on the apparatus 10 and the desired processing, the measuring instrument 50 may be a pressure, differential pressure, temperature, level measurement, or other measurement device or sensor. As shown in FIG. 1, the exemplary measuring instrument 50 is connected to both instrument taps 40 through conduits 46 to obtain a differential pressure measurement between location 42 and location 44. For differential pressure measurement, the measuring instrument 50 may include a diaphragm or an arrangement of diaphragms. For example, a single diaphragm may have one surface connected to the conduit 46 in communication with the instrument tap 40 at location 42, and its other surface connected to the conduit 46 in communication with the instrument tap 40 at location 44. Deformation or deflection of the diaphragm is dependent on the pressure difference between its surfaces, and can be measured using mechanical, optical or capacitive techniques to obtain a differential pressure. Alternatively, each conduit 46 can be connected to a dedicated diaphragm which may be open to atmosphere to measure gauge pressure, sealed to a fixed reference pressure or to vacuum to measure absolute pressure, or connected to each other to measure differential pressure using volume displacement.

While the embodiment illustrated in FIG. 1 shows both the instrument tap 40 at location 42 and the instrument tap 40 at location 44 connected to the same measuring instrument 50, in other exemplary embodiments each instrument tap 40 may be provided with a dedicated measuring instrument 50. Further, in certain exemplary embodiments, each instrument tap 40 may be connected to more than one measuring instrument 50.

As shown, the apparatus 10 includes a purge gas header 54 which supplies a purge gas, identified by arrows 56, to the conduits 46. Typically, the purge gas 56 is supplied to the conduits 46 at a constant pressure through a conduit 58. In an exemplary embodiment, the purge gas 56 is air and is supplied at a pressure of about 50 psig (3.447 bar) to about 100 psig (6.895 bar) and the conduit 58 has a ¾-inch (1.905 cm) diameter. During flow from the purge gas header 54, the purge gas 56 passes through a strainer to remove any particulates and through a flow regulator, such as an orifice plate with sixteenth-inch (0.15875 cm) diameter orifice, before passing into the conduit 46. To purge the instrument tap 40 at location 42 and the instrument tap 40 at location 44, the purge gas 56 is urged through conduits 58 and conduits 46. As the purge gas 56 flows, it dislodges and removes any solid particles that may accumulate in the conduits 46 or the instrument taps 40 and carries the particles into the process unit 12, i.e., the purge gas 56 purges the instrument taps 40 and conduits 46.

During conventional processing, purge gas is continuously flowed through instrument taps while measurements are obtained by measuring instruments. However, as the purge gas is typically air, it adds additional, and often undesirable, amounts of oxygen to the process unit. The additional oxygen can inhibit economical processing of the feedstock and result in a yield reduction for the product oil. Therefore, to reduce the amount of oxygen added to the process unit 12, the exemplary apparatus 10 provides for reducing the amount of purge gas 56 added to the process unit 12. Specifically, the apparatus 10 provides for non-continuous purges of the instrument taps 40 and conduits 46 with the purge gas 56. Accordingly, the apparatus 10 provides for non-continuous process condition measurement with the measuring instrument 50.

To provide for non-continuous purging and non-continuous process condition measurement, the apparatus 10 includes valves 60 located on the conduits 46 to close and open fluid flow therethrough. Valves 60 may be actuated block valves that operate with binary off/on signals. During operation, valves 60 are in a closed configuration unless opened by a signal. Typically, the valves 60 move to an opened configuration for a purge/measurement period duration upon receiving an open signal. Then, the valves 60 automatically return to the closed configuration, blocking flow of the purge gas to the process unit 20 and interrupting fluid communication between the process unit 20 and the measuring instrument 50.

Apparatus 10 further includes a controller 64 electronically connected to the measuring instrument 50 and to valves 60. The controller 64 utilizes a software algorithm to monitor the measurements, or measured process conditions, obtained by the measuring instrument 50. Based on the monitored measurements over time, the controller 64 identifies process variability or process trend and determines a measurement schedule or frequency, i.e., how often measurements in the process unit 12 should be taken in order to maintain sufficient process control. In typical processing, the measured process conditions are used to determine whether processing changes are needed, such as changes to flow rates, temperatures, pressures, etc. When process variability is volatile, more frequent measurements are needed to ensure proper processing changes are being made. On the other hand, when the process trend is relatively steady, the measurement frequency may be reduced. In either situation, the controller 64 sends the open signal to the valves 60 according to the measurement frequency. In response, the valves 60 move to the opened configuration, the measuring instrument 50 measures the process condition at location 40 and at location 42, and the purge gas 56 flows through and purges the conduits 46 and instrument taps 40. At all other times, the valves remain closed and no unnecessary air, and hence oxygen, is delivered to reactor 20.

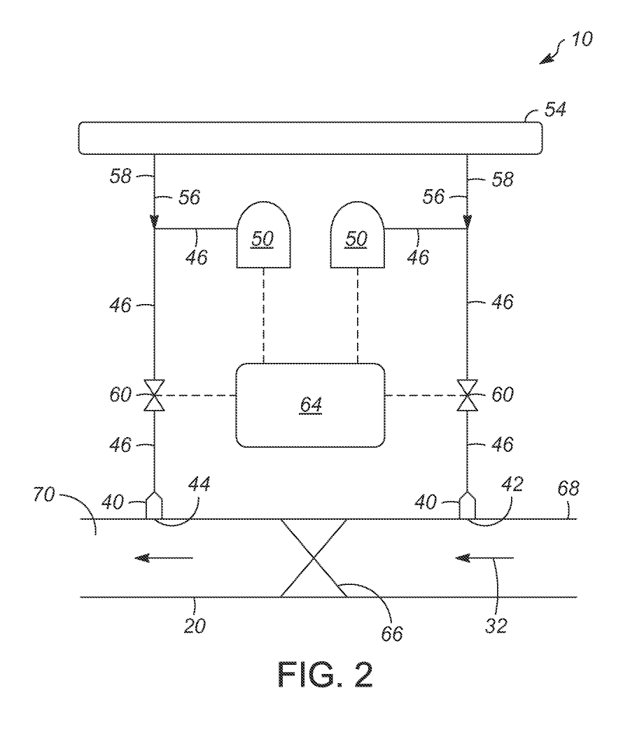

Referring now to FIG. 2, an exemplary apparatus 10 is illustrated for use on a process unit 20, such as a valved pipe, through which a fluidized solid stream 32 flows. As shown, the process unit 20 includes a valve or flow restrictor 66 which defines a high pressure side 68 and a low pressure side 70 within the process unit 20. The process unit 20 is provided with an instrument tap 40 at a location 42 and an instrument tap 40 at location 44. Each instrument tap 40 defines an inner channel in fluid communication with the process unit 20 and in fluid communication with a conduit 46. Each conduit 46, in turn, is in fluid communication with a separate measuring instrument 50. Thus, location 42 and location 44 in the process unit 20 are both in fluid communication with a dedicated measuring instrument 50 through the conduits 46 and taps 40. The measuring instruments 50 may be in fluid and/or electronic communication depending on the measurement desired to be obtained.

Each measuring instrument 50 of FIG. 2 is connected to a respective instrument tap 40 through a respective conduit 46 to provide for obtaining a pressure measurement. However, the measuring instruments 50 may be selected and used to measure any measurable process condition at locations 42 and 44. The apparatus 10 includes a purge gas header 54 which supplies a purge gas, identified by arrows 56, to the conduits 46 through conduit 58. To purge the instrument tap 40 at location 42 and the instrument tap 40 at location 44, the purge gas 56 is flowed through conduits 58 and conduits 46. As the purge gas 56 flows, it dislodges and removes any solid particles that may accumulate in the conduits 46 or the instrument taps 40 and carries the particles into the process unit 20, i.e., the purge gas 56 purges the instrument taps 40 and conduits 46.

The exemplary apparatus 10 includes valves 60 located on the conduits 46 to close and open fluid flow therethrough. Valves 60 may be actuated block valves that operate with binary off/on signals. During operation, valves 60 are in a closed configuration unless opened by a signal. Typically, the valves 60 move to an opened configuration for a selected purge/measurement period duration upon receiving an open signal. While the valves 60 are open, the measuring instruments 50 may obtain or record a measurement of a process condition while purge gas 56 purge the conduits 46 and instrument taps 40. Then, the valves 60 automatically return to the closed configuration, blocking flow of the purge gas the process unit 20 and fluid communication between the process unit 20 and the measuring instrument 50.

Apparatus 10 further includes a controller 64 electronically connected to the measuring instruments 50 and to valves 60. As described above, the controller 64 utilizes an algorithm to monitor the measurements, or measured process conditions, obtained by the measuring instruments 50, identifies process variability or process trend, and determines a measurement schedule or frequency. The controller 64 then sends the open signal to the valves 60 according to the measurement frequency. In response, the valves 60 move to the opened configuration, the measuring instrument 50 measures the process condition at location 40 and at location 42, and the purge gas 56 flows through and purges the conduits 46 and instrument taps 40.

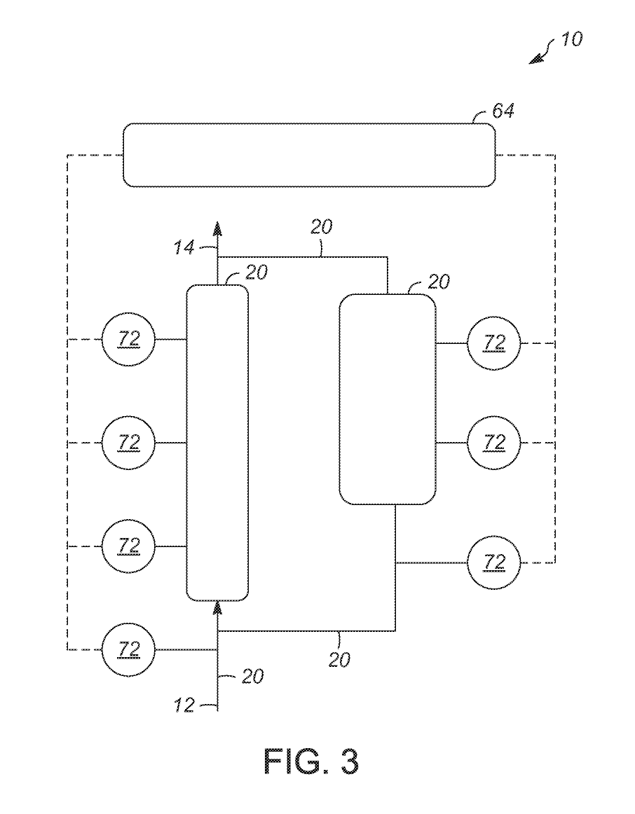

Referring to FIG. 3, an apparatus 10 is shown with a plurality of process units 20, including vessels, conduits or other chambers interconnected to process a feedstock 12 into a product 14 as desired. Further, the apparatus 10 is provided with a plurality of measurement/purge units 72. Each measurement/purge unit 72 includes at least one instrument tap (not shown) in fluid communication with the respective process unit 20; a conduit providing fluid communication between each instrument tap and a measuring instrument; a purge gas source connected to the conduit; and a valve for selectively opening and closing the conduit and located between the instrument tap and the measuring instrument and between the instrument tap and the purge gas source.

As shown, each measurement/purge unit 72 is electronically connected to a controller 64. As described above, the controller 64 monitors the measured process conditions obtained by the measuring instruments, sets a measurement frequency based on the measured process conditions, and selectively opens the valves according to the measurement frequency that it sets. The controller 64 can dynamically modify the measurement frequency in real-time upon receiving new measurements from the measuring instruments. As the controller 64 is electronically connected to measurement/purge units 72 at locations throughout the apparatus 10, the controller 64 can universally monitor process conditions throughout the apparatus 10. Further, because different locations in the apparatus 10 may operate under different regimes, such as for example, level control, flow control, or pressure control, the controller 64 may set measurement frequencies that vary between the measurement/purge units 72 and, hence, locations within the apparatus 10.

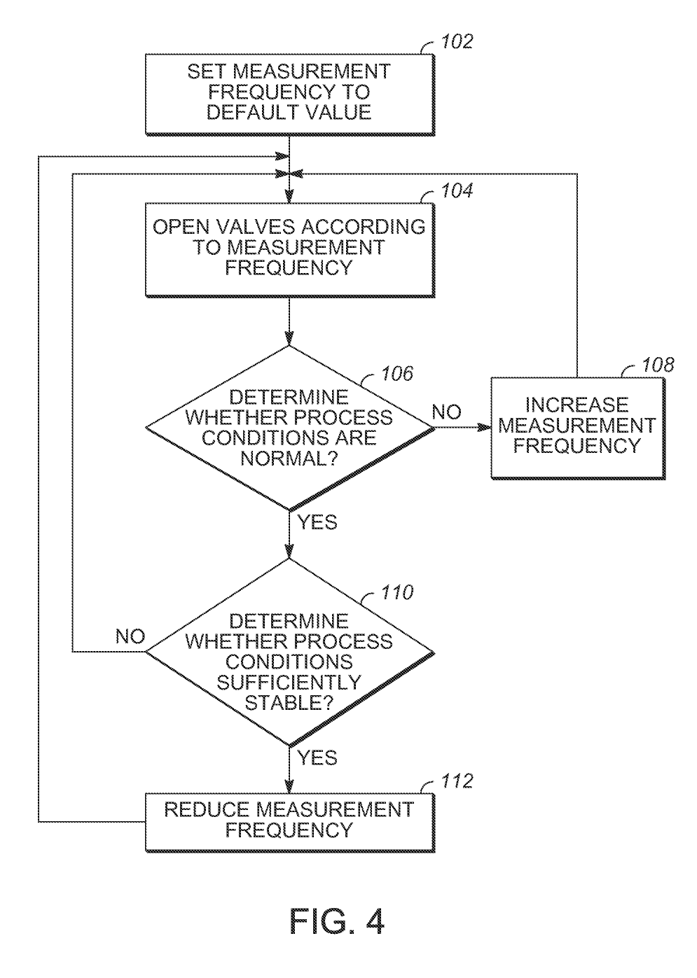

FIG. 4 illustrates a process for selectively measuring process conditions and purging instrument inlets. At step 102, a measurement frequency is set at a default or start-up frequency. At step 104, valves are opened according to the measurement frequency, process conditions are measured and instrument taps are purged. In view of the newly obtained measured process conditions, the controller determines whether the measured process conditions are within a normal range at step 106. If not, the measurement frequency is increased at step 108 before process conditions are measured further. If the controller determines that process conditions are within a normal range, then the controller determines whether the process trend is sufficiently stable to reduce the measurement frequency at step 110. If so, the measurement frequency is reduced at step 112 before process conditions are measured further. If not or if inconclusive, the measurement frequency remains unchanged and measurements continue.

In view of the apparatuses in FIGS. 1-3 and the process outlined in FIG. 4, the processes and apparatuses disclosed herein convert a feedstock under conditions with a reduced level of oxygen. Specifically, the amount of oxygen introduced to process units in the apparatus is minimized while providing sufficient system control by intermittently obtaining measurements by measuring instruments and by intermittently purging the instrument taps. As a result, the processes and apparatuses herein can be used to efficiently convert feedstock with minimized yield loss.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the processes without departing from the scope defined by the claims, which includes known equivalents and foreseeable equivalents at the time of filing this patent application.

What is claimed is:

1. A process for converting biomass, the process comprising the steps of:
flowing the biomass and a gas through a process unit;
providing a default value for a frequency of measuring a process condition in the process unit;
measuring the process condition according to the frequency to obtain process condition measurements;
evaluating the process condition measurements to assess the stability of the process condition; and
determining whether to change the default value depending on the stability of the process condition.

2. The process of claim 1 wherein the process unit includes an instrument tap, wherein measuring the process condition comprises measuring the process condition through the instrument tap, and wherein the process further comprises purging the instrument tap while measuring the process condition.

3. The process of claim 2 wherein purging the instrument tap comprises flowing a purge gas from a purge gas source through a measuring line to the instrument tap.

4. The method of claim 3 wherein measuring the process condition comprises measuring the process condition with a measuring instrument fluidly connected to the process unit by the measuring line.

5. The method of claim 4 wherein fluid communication through the measuring line is selectively opened by a valve, and wherein measuring the process condition comprises opening the valve according to the frequency.

6. The process of claim 5 wherein evaluating the process condition measurements comprises evaluating the process condition measurements with a controller electronically connected to the valve and the measuring instrument, wherein determining whether to change the default value comprises determining whether to change the default value with the controller, and wherein measuring the process condition comprises opening the valve in response to an open signal from the controller.

7. The process of claim 1 wherein measuring the process condition comprises measuring the process condition at a first location in the process unit and at a second location in the process unit according to the frequency to obtain process condition measurements.

8. The process of claim 7 wherein the process unit includes a first instrument tap at the first location and a second instrument tap at the second location, wherein measuring the process condition comprises measuring the process condition at the first location through the first instrument tap and at the second location through the second instrument tap, and wherein the process further comprises:
purging the first instrument tap while measuring the process condition at the first location; and
purging the second instrument tap while measuring the process condition at the second location.

9. The process of claim 8 wherein purging the first instrument tap comprises flowing purge gas from a purge gas source through a first measuring line to the first instrument tap, wherein purging the second instrument tap comprises flowing purge gas from the purge gas source through a second measuring line to the second instrument tap, and wherein measuring the process condition comprises measuring the process condition at the first location through the first measuring line and at the second location through the second measuring line.

10. A process for monitoring a fluidized solid stream comprising:
contacting a gas with solids to form the fluidized solid stream;
intermittently opening fluid communication with the fluidized solid stream through a tap at a first frequency; and
measuring a process condition at the tap to obtain measured process conditions and simultaneously purging solids from the tap while fluid communication with the fluidized solid stream is open.

11. The process of claim 10 wherein intermittently opening fluid communication with the fluidized solid stream comprises selectively opening a valve, wherein the valve opens fluid communication between the tap and a measuring instrument and between the tap and a gas source, and wherein measuring the process condition comprises measuring the process condition with the measuring instrument.

12. The process of claim 11 wherein intermittently opening fluid communication is performed by a controller that is adapted to selectively open the valve.

13. The process of claim 12 further comprising:
monitoring the measured process conditions with the controller;
determining a second frequency for opening fluid communication with the fluidized solid stream based on the measured process conditions using the controller; and
opening fluid communication with the fluidized solid stream through the tap according to the second frequency.

14. The process of claim 10 wherein intermittently opening fluid communication comprises intermittently opening fluid communication between the fluidized solid stream and a measuring instrument adapted to measure a process condition in the fluidized solid stream, and wherein the process further comprises:
monitoring the measured process conditions with a controller electronically connected to a valve and to the measuring instrument; and
determining with the controller a second frequency for opening the valve based on the process condition, wherein the controller selectively opens the valve based on the second frequency.

15. The process of claim 10 further comprising:
monitoring the process condition; and
determining a second frequency for opening fluid communication with the fluidized solid stream based on the process condition.

16. The process of claim 10 further comprising connecting a gas source to the tap, wherein purging solids from the tap comprises flowing a gas from the gas source to the tap to purge solids therefrom.

17. The process of claim 10 wherein contacting a gas with solids comprises contacting biomass, heat transfer medium, and a carrier gas to form the fluidized solid stream.

18. The process of claim 10 wherein the tap is a first tap, and wherein intermittently opening fluid communication with the fluidized solid stream comprises opening fluid communication with the fluidized solid stream through a second tap, measuring another process condition at the second tap, and simultaneously purging solids from the second tap.

19. The process of claim 18 wherein intermittently opening fluid communication with the fluidized solid stream through the first tap and through the second tap comprises selectively opening a first valve and a second valve, wherein the first valve opens fluid communication between the first tap and a measuring instrument and between the first tap and a gas source, and wherein the second valve opens fluid communication between the second tap and the measuring instrument and between the second tap and the gas source, wherein the process condition is pressure; and wherein the process further comprises:
calculating pressure differentials between the pressure at the first tap and the pressure at the second tap with a controller electronically coupled to the first valve, the second valve, and the measuring instrument;
monitoring the pressure differentials with the controller; and
determining a second frequency for opening the first valve and the second valve with the controller based on the pressure differentials, wherein the controller simultaneously opens the first valve and the second valve according to the second frequency.

20. An apparatus for converting a feedstock to bio-oil comprising:
a conversion reactor for receiving the feedstock and including a reaction zone adapted to convert the feedstock to bio-oil;
a tap connected to the reaction zone;
a measuring instrument fluidly connected to the tap by a conduit, the measuring instrument configured for measuring a condition in the reaction zone;
a valve connected to the conduit between the measuring instrument and the tap for selectively opening and closing fluid communication therebetween;
a gas source connected to the conduit between the valve and the measuring instrument for purging the tap of solids; and
a controller electronically connected to the measuring instrument and the valve, wherein the controller is configured to intermittently open the valve to obtain a condition measurement and to simultaneously purge the tap of solids.
